(19) United States
(12) Patent Application Publication
(10) Pub. No.: US 2006/0157194 A1
(43) Pub. Date: Jul. 20, 2006

(54) Method for the production of a laminate, device for carrying out the method and corresponding laminate

(76) Inventor: Stefan Bachstein, Gattendorf (DE)

Correspondence Address: 24IP LAW GROUP USA, PLLC, 12 E. LAKE DRIVE, ANNAPOLIS, MD, 21403, US

(21) Appl. No.: 10/564,664

(22) PCT Filed: Jul. 15, 2004
(86) PCT No.: PCT/EP04/07918

§ 371 Date: Jan. 13, 2006

(30) Foreign Application Priority Data
Jul. 15, 2003 (DE) 103 32 052.0

(51) Int. Cl. C09J 5/00; B32B 37/00; B29C 65/00

(52) U.S. Cl. 156/305; 156/539

(57) ABSTRACT

The invention relates to a method for the production of a laminate with continuous feed of one or two process films, application of a continuous essentially non-polymeric semi-finished web, for example, of metal, on or between the process films, optional sealing of the semi-finished web relative to the or one of the process films, application of a curing plastic to the semi-finished web or between the semi-finished web and the other of the process films and curing of the plastic to give a bond between the plastic and the semi-finished piece. The invention further relates to a device for carrying out the method and the laminates, in particular, metal/plastic laminates produced by said method.

The present invention concerns a method for manufacturing a laminate, as well as an device for carrying-out the method and a thereby obtained laminate, which especially may be a GFK/aluminum laminate which, for example, is applicable in vehicle construction for design of truck superstructures and the like or side walls of caravans or motor homes.

Nowadays, in this above named specific application are often used GFK plates which partially are formed as so-called structural sandwich elements. Such elements may be subject to a surface degradation or surface yellowing though, and in times the surface properties are not sufficient for specific applications.

The applicant did already propose a laminate and a method (DE-A-195 10 237), substantially in order to strengthen polymeric layer-pressed materials with GFK. By means of the known method, a separate gluing of respective decor foils can be avoided, in that a so called Gelcoat layer is replaced by a pre-manufactured polymer material. Therefore, the known method and laminate obviate an involved procedural step, but there doesn't result a structural advantage.

As alternative(s), aluminum sheets are used for this purpose until now. However, the material properties, being unfavorable under mechanical load, as well as the remaining synthetics deformations, for example during hailstorm, are problematic, although the surface properties, as for example the paintabilitiy, are better, as compared to the above named GFK products however.

Accordingly, during the last years, experiments were carried out increasingly to draw benefit of both material properties.

For example, DE-A-19918736 proposes a compound material, wherein the metal cover layer is glued to an underlying material. Compound materials needing a metal band to be glued to a prefabricated synthetics plate are not economical from the point of view of process engineering, and require a high amount of care when gluing. Further, such glued compound materials usually only allow for a small deformation, and the resulting compound material frequently does not fulfill the intended requirements, because the metal layer is easily scratched and deformed when gluing, whereas the synthetics component and/or the metal component is contaminated by the gluing itself.

From DE-A-19646438, a method for manufacturing two-dimensional GFK form plates is known, wherein formed parts may then be glued to a metal band, as for example is mentioned further above.

From another technical area, namely the production of ski, synthetics/metal layer structures are known, see for example DE-A-3913969 and DE-A-3636645. In the production of ski, a metal structural element is usually laid into a molding tub, which is then completely molded-in by resin. Accordingly, only part of the advantages of metal are used herein. Especially, such a method cannot take advantage of the surface properties, like paintability and the like.

Accordingly, there is a need for laminates, for an effective method to manufacture a laminate, as well as for a respective device for manufacturing laminates, such that improved structure and surface properties are provided. Therefore, the object of the present invention is to provide a method and a said device, which are adapted to carrying-out said method.

Besides high efficiency, the method should provide the possibility to produce laminates using substantially non-polymeric semi-manufactured product, especially having suitable structural properties and surface properties, as for example a surface treated metal, which possesses excellent stability properties and surface properties. In fact, and in an extremely surprising manner, it has turned out that a synergy effect occurs, if a substantially non-polymeric semi-manufactured product is additionally made run-in, when manufacturing the laminate. Besides the optimized surface properties, the structural properties of the laminate are substantially improved as well, which actually not has been to be expected, since the person skilled in the art had to assume that only polymeric semi-manufactured products, as for example the layer-pressed materials proposed by the applicant, would provide a sufficiently deep association with the synthetics forming the laminate.

The method according to the invention for manufacturing a laminate comprises the following steps: providing at least one continuous process foil; depositing a continuous, substantially non-polymeric band of semi-manufactured product to the process foil; sealing the semi-manufactured product band with respect to the process foil; applying a hardenable synthetics to the semi-manufactured product band; and hardening the synthetics, while providing a bonding between the synthetics and the semi-manufactured product. One substantial feature of the method according to the invention is, that it is a continuous method, with continuous supply of the various materials and components, so that there can be provided a laminate with practically unlimited dimensional possibilities. A further substantial feature of the method according to the invention is that the bonding between the semi-manufactured product and the synthetics is effected by the hardening itself, so that the until now necessary separate gluing step may be omitted, whereby the problems, which might otherwise occur when gluing are avoided. The use of process foil has the advantage, that the whole synthetics mass and the semi-manufactured product may be guided on the process foil, so that a contamination of the tools may be avoided, which increases the productivity, especially in the continuous method proposed herein, since, to the one hand, the method does not need to be interrupted for cleaning purposes, and, to the other hand, contaminations cannot lead to a detraction of the manufactured product. As substantially non-polymeric semi-manufactured product, as used herein, is especially meant a structural intermediate product, which is, for example, surface-treated. By means of the sealing of the process foil with respect to the semi-manufactured product, particularly a metal band, there may not occur a contamination of the synthetics itself, for example also resin at the side covered by the process foil, so that it is, for example, also possible, to provide a surface treated metal band, which in view of its later application might, for example, be anodized or might also be painted. The sealing step may, for example, be carried out by means of a gluing tape, which is continuously introduced to the edge region of the semi-manufactured product band, and preferably is pressed-on. Alternatively, a gluing between the semi-manufactured product band and the process foil by means of a fluid glue or by means of a double sided gluing tape is possible as well.

Moreover, this sealing by means of gluing makes sure, in an advantageous manner, that possible lateral edge corrugations of the semi-manufactured product band are pressed down or smoothened, respectively. Thereby, a more effective exploitation of material results, especially in the edge regions.

In a preferred embodiment, the method comprises the step of depositing a second continuous process foil to the hardenable synthetics. By means of the provision of two continuous process foils, it is possible to protect the laminate from contaminations during the entire procedure, since it is bordered between the process foils in a sandwich-like manner.

Preferably, the method further comprises the step of introducing reinforcement material into the hardenable synthetics. This step may be combined with depositing the hardenable synthetics, in that for example a respective casting slip or a fiber projecting method is applied or are effected separately. The reinforcement material, which may for example be present in form of fiberglas mats or other kinds of reinforcement material, is preferred, in order to increase the structural properties of the hardenable synthetics, and thereby of the whole laminate. Although reinforcement materials which may be rippled and which can also be supplied continuously may be applied as well, it is easiest for the method, from the point of view of control engineering, to use a reinforcement material in band form as well, as for example fiberglas mats or tissue, which is commercially available in form of rolls, but in the context of the invention is not denoted as semi-manufactured product. Arbitrary kinds and structures of fibers are applicable. Only as examples, glass, carbon, aramid, natural fibers and so on may be named as fibers, and tissue, chaff mats, endless mats, fleece and roving may be named as fiber structures.

In case of a preferred embodiment of the method according to the invention, there is further provided a calendering step, wherein especially a calender is disposed immediately before the hardening zone, so that the step of calendering takes place immediately prior to the hardening. To the one hand, the calenderings allows for a high plane parallelism, and, to the other hand, for an effective permeation and/or deairing. In case of an especially preferred embodiment, one of the calender rolls forms a deflection facility for one of the process foils.

In order to be able to prevent air inclusions, and/or in order to provide a tightly fitting protecting process foil for the semi-manufactured product, especially the metal band, it is preferred, that in the method according to the invention the space between the process foils and/or a process foil and the semi-manufactured product is evacuated, the term evacuated being understood as an arbitrarily chosen reduced pressure.

In the context of the method according to the invention, it is preferred that at least one process foil extends laterally beyond the semi-manufactured product band, to allow for an engagement by transport means. In that at least one of the process foils is made projecting laterally beyond the semi-manufactured product band, it is possible to secure a forward movement of the continuously produced laminate at any time during the procedure, without an engagement with the synthetics surface or the semi-manufactured product surface being necessary, so that an additional protection function may be provided to maintain the integrity of the respective surfaces. To state it differently: according to this embodiment, the laminate may therefore be guided outside of the usable area, as far as transport technology is concerned.

In a further preferred embodiment of the method according to the invention, when two process foils are used, these may be brought into engagement laterally alongside the semi-manufactured product, and may especially be brought into engagement with each other in a sealing manner, so that the process foils may form a kind of flat hose, inside which the laminate is constructed, possibly calendered and hardened, wherein a lateral sealing prevents that the synthetics material, for example resin prior to hardening, exits laterally, whereby an even better protection function with respect to a contamination of the apparatus itself is provided.

Preferably, the semi-manufactured product band is a semi-manufactured product band, which is substantially impermeable for the hardenable synthetics, in order to draw profit, in a practically independent manner of the respective structural properties.

In the context of the method according to the invention, there may especially be applied a surface treated or coated metal band, wherein the coating, to the one hand, may provide an improved bonding with respect to the synthetics, for example in form of a primer or the like and/or also a coating which presents the visible surface during later-on use.

In summary, it may be noted, that by means of the method according to the invention continuous laminates may be manufactured in an especially simple and effective way by inserting substantially non-polymeric semi-manufactured product, wherein the laminate package is guided on a/one, and especially between two, continuously running process foils, one of which preferably protects the semi-manufactured product surface, being later-on the surface of the laminate, from synthetics, resin and the like, while the other process foil protects and influences the surface properties of the other side of the laminate. The skilled person will notice, that various process parameters and materials may be applied; only as an example, it shall be noted, that unsaturated polyester resin, vinyl ester resin, epoxy resin is used for the synthetics material, while the semi-manufactured product preferably consists of aluminum or its alloys, of steel or of zinc coated steel. The process foils itself may, for example, be polyester foils, so that, for example, a light induced hardening may be thought of, in case the process foils are provided in a transparent manner. Although not explicitly noted, the skilled person will further understand that besides resin and hardener additionally respective deairing additives and accelerators are applied of course. As indicated, the method according to the invention is distinguished by a high productivity, which, for example, may be provided by means of a transport velocity of about 2-6 m/min.

Besides the method according to the invention, the invention is also directed to a device for carrying-out the method. Such a device for carrying-out the invention comprises a material storage to continuously issue at least one process foil, a storage/dispensing device for continuously providing a substantially non-polymeric semi-manufactured product, especially a semi-manufactured product band, a sealing facility to seal the semi-manufactured product with respect to the process foil, as well as a facility for storing and dispensing hardenable synthetics in a continuous manner. Especially preferably, the different process foil(s) and components of the laminate to be formed are provided in wound form, wherein also the product, i.e. the hardened polymer, may be dispensed as wound product, also called coil.

Optionally, as indicated, the device also includes a second material storage for the second process foil.

In a preferred embodiment, the sealing facility for sealing the semi-manufactured product with respect to the or one of the process foil(s) comprises a gluing tape dispensing facility having optional impact means and an optional counter-pressure unit. Therefore, a back-running of the surface of the semi-manufactured product may be avoided in an effective manner. It is to be noted that other sealing manners are also possible, like especially a fluid glue and a double sided gluing tape, which is to be provided as an intermediate layer between the semi-manufactured product band and the process foil.

Advantageously, the device comprises a synthetics distributing and/or impact facility, especially in the form of a spreading knife and/or a calender. By means of such an embodiment, a homogeneous film thickness of the unhardened synthetics can be assured, wherein one calender is especially preferred for application of additional reinforcement material, since thereby/therefore a suitable permeation can be assured in a better way.

In order to be able to introduce a reinforcement material into the hardenable synthetics in a continuous manner, it is preferred that the device further comprises a facility for storing and continuous dispensing of reinforcement material. The reinforcement material may for example be provided in form of woven fiberglas mats in form of rolls, so that the continuous supply may be provided in an especially simple manner, in the context of which it should be noted that also reinforcement materials which are able to ripple or are pourable may be applied though.

In order to be able to initiate or accelerate the hardening of the hardenable synthetics, it is preferred that the device according to the invention further comprises a heating facility, especially for a continuously feedable heating and tempering table. As an example, such a heating and tempering table may be immediately following to a calender roller mill, so that it is possible to substantially maintain the configuration, which is present behind the calender, for the end product.

In order to be able to allow for a continuous transport of the laminate and the laminate components, there is advantageously provided a forwarding means, which may be brought to engagement with at least one of the process foils alongside the semi-manufactured product band, for example of metal. By means of the forwarding means, which is disposed laterally alongside the semi-manufactured product, an effective transport through the device is possible, without an immediate engagement at one of the surfaces of the end product being necessary.

Finally, it is preferable that in such a device the forwarding means be embodied in such a manner, that a sealing engagement between two process foils is allowed for, whereby a lateral exiting of the not yet hardened synthetics material is avoided at least in sections.

In a special embodiment of the present invention, the method for manufacturing the laminate comprises the steps: providing a support surface 370 having predetermined dimensions; providing at least one optional first process foil 311; depositing a substantially non-polymeric semi-manufactured product band 331 to the support surface or the optional first process foil 311; sealing the semi-manufactured product band 331 with respect to the support surface or the optional first process foil 311; depositing a hardenable synthetics 341 to the semi-manufactured product band 331; and hardening the synthetics while depositing a bonding between the synthetics and the semi-manufactured product.

An important feature of this embodiment of the method according to the invention is that especially for the step of depositing the hardenable synthetics 341 to the semi-manufactured product band 331 a relative movement is generated between the support surface 370 and a laminating unit, by means of which the synthetics 341 is applied. Since in this special embodiment the semi-manufactured product rests on the support surface, the interposing of a first process foil may in principle be omitted. In this case, the sealing of the semi-manufactured product band is effected with respect to the support surface. Due to reasons of the above mentioned cleaning aspects, it may also be advantageous to interpose a first process foil 311 between the support surface and the semi-manufactured product band though, so that the sealing of the semi-manufactured product band is effected with respect to the first process foil in this case. In the following, the advantages of this special embodiment correspond to the above described ones. Especially, by means of the sealing of the semi-manufactured product with respect to the support surface or the process foil, respectively, it is assured that no material may run below the semi-manufactured product, and that a possible edge undulation of the semi-manufactured product is smoothened and leveled out. Both increases especially the material yield an resulting laminate.

The invention is further directed to a special embodiment of a device for carrying-out the method, comprising: a support surface 370 having predetermined dimensions, an optional material storage 310 for dispensing of at least one optional first process foil 311, a storage dispensing device 330 for provision of a substantially non-polymeric semi-manufactured product band 331, a sealing device for sealing the semi-manufactured product with respect to the support surface or the optional process foil, as well as at least one laminating device 340 for storing and dispensing of hardenable synthetics 341. The storing and dispensing of the hardenable synthetics 341 by means of the laminating device is effected by lateral movement of either the support surface 370 and/or the laminating device 341 with respect to each other. By means of such an embodiment, it is possible, that the substantially non-polymeric semi-manufactured product band 331 rests on the support surface, so that in principle the use of an optional first process foil 311 may be omitted. In this case, the sealing of the semi-manufactured product with respect to the support surface is effected by means of the provided sealing facility. Optionally, prior to the provision of the semi-manufactured product (“halbzeit”) band, a process foil 311 may be disposed on the support surface 370, whereby the above named advantages, especially with respect to the omitted cleaning of the device, present themselves.

Further, the manners of operation and the advantages of the additional features of this special embodiment correspond to the above mentioned. By means of the sealing facility for the sealing of the semi-manufactured product with respect to the support surface or processing foil, respectively, it is especially assured that no material may run below the semi-manufactured product, and that a possible edge undulation of the semi-manufactured product is smoothened and leveled out. Both increases especially the material yield of resulting laminate.

The synthetics/metal laminates manufactured by means of the method according to the invention are distinguished by a good regularity of the surface at the side(s) provided with a processing foil; such good surface regularities, in an especially surprising manner, are provided by the method according to the invention, especially because the synthetics material is immediately laminated to the metal, wherein the surface is determined by a suitably chosen processing foil during the manufacturing procedure. The synthetics/metal laminates manufactured by the method according to the invention are further distinguished by a very high bonding between metal and synthetics, which may especially resist a high shear demand and/or an impact demand without modification of the laminate structure. Such high surface bondings have not been available until now, and especially may not be manufactured by gluing separately manufactured individual elements. During ballistic impact with spheres of 20 mm at a velocity of 20 m/s, the laminates do not show any deformation.

Further advantages and features of the present invention result from the following description of a presently preferred embodiment, which is presented as an example only. In the following description, reference is made to the accompanying drawings, wherein:

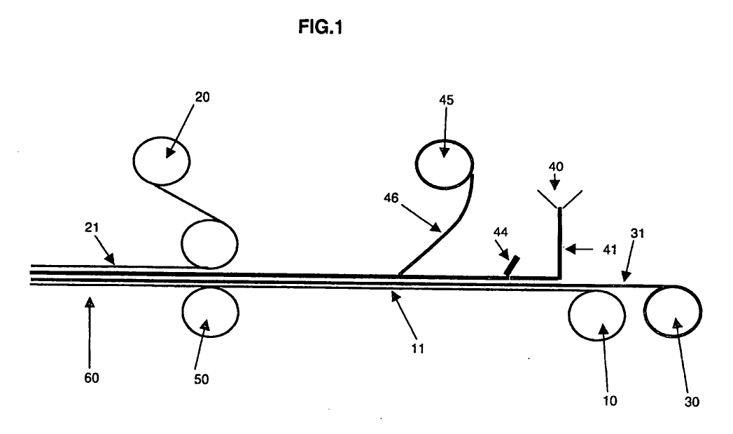

FIG. 1, in schematic side view, shows a device for manufacturing a synthetics/metal laminate, as preferred embodiment of the invention, and for the purpose of illustrating the method according to the invention.

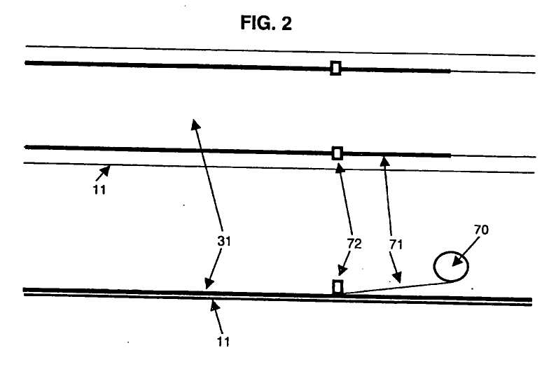

FIG. 2, in schematic planview and side view, shows a possibility to provide the sealing between semi-manufactured product band and process foil.

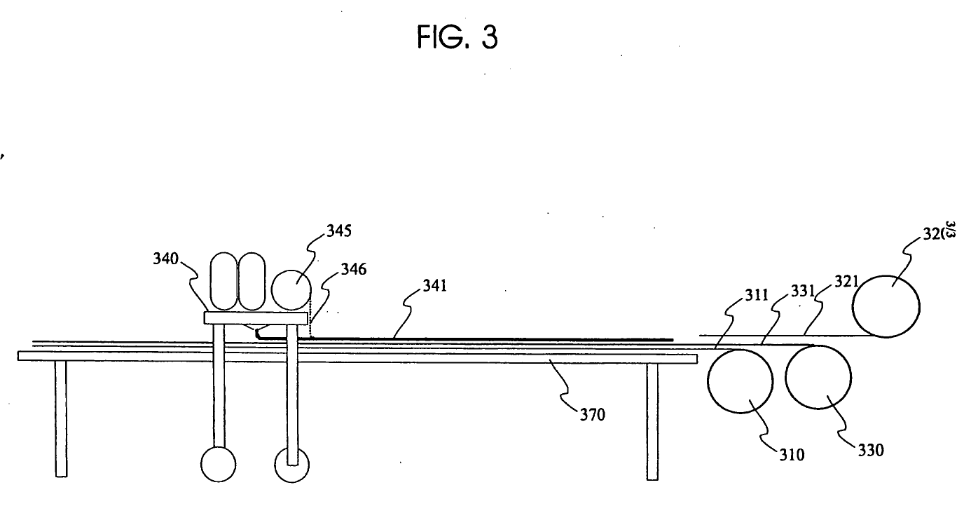

FIG. 3, in schematic side view, shows another embodiment of the device for manufacturing a synthetics/metal laminate, as preferred embodiment of the invention, and for the purpose of illustrating the method according to the invention.

In FIG. 1, in schematic side view, a device is shown, which allows for the manufacturing of a synthetics/metal laminate. In the shown embodiment, the device comprises a first metal storage 10, which may be continuously dispensing a process foil 11, which serves as support foil in the shown embodiment. In the shown embodiment, this is a 100 μm polyester foil, which may be unwound of a roll, as shown. The shown device further comprises a storage/dispensing facility 30 for continuously providing a metal band 31, which, as is indicated, is supplied in such a manner, that it comes to lie immediately above the process or support foil 11. It is to be noted, that the width of the process foil 11 should be at least as high as that of the metal band 30, in the context of which, as explained later on, it is especially preferred that the process foil 11 is broader than the metal band 31. In the region, where the process foil 11 and the metal band are combined, an optional sealing facility, shown in FIG. 2, is provided, which adheres the process foil 11 to the lateral edges of the metal band 31, so that a fluid substance or a substance capable of flowing at the top side of the metal band may neither reach the side faces nor the bottom side of the metal band.

As shown in FIG. 2, although a sealing is also possible by means of a fluid glue or by means of a double sided gluing tape between semi-manufactured product and process foil, in an especially preferred manner, a gluing tape 71 may be provided by a roll 70, in such a manner that it overlays the edge of the semi-manufactured product 31, and be connected with both, the process foil and the semi-manufactured product by means of an contact pressure facility.

The device shown in FIG. 1 further comprises a facility 40 for storing and dispensing hardenable synthetics 41 in a continuous manner. In the shown embodiment, for example an un-saturated polyester resin is concerned, which possibly may be mixed with a suitable hardener immediately prior to the dispensing, and be dispensed in a suitably dosed manner, so that on the upper face of the metal band 31 a resin lake is formed. In the shown embodiment, a spreading knife 44 is provided for distributing the fluid synthetics, which may allow for a first stripping smooth and may assure that the whole surface of the metal band is covered by resin.

However, since according to the invention and optionally preferably reinforcement materials, as for example fiberglass mats, may be applied, according to the shown embodiment there is further provided a facility 45 for storing and continuous dispensing of reinforcement material. Herein, the supply of reinforcement material is effected in such a manner that the fiberglass mat 46 runs into the resin layer distributed by means of the spreading knife 44. After the supply of reinforcement material 46, a second process foil from a second material storage 20 is finally supplied, before the whole thereby formed package of lower process foil and metal band 31, being sealed with respect to the process foil 11, having raisin 41 with reinforcement material 46 embedded therein, and the process foil 21 enters a calender 50, subsequent to which follows a hardening facility, as for example a heating and tempering table 60.

As already manifestly results from the presented different supplies of the process foils and materials, a substantial aspect of the invention can be seen in that the method is carried out continuously, the individual supply stations being given in a stationary manner, while the materials individually, and later-on as a package, are moving through the device in a continuous manner. In order to be able to provide for the above mentioned movement, it might generally be thought of using an advance though, which might be provided by means of the calender or subsequent rolls; but since the invention is especially directed to avoiding a damage of the surface of the semi-manufactured product, and, to the other hand, to provide a high surface planity with respect to the synthetics, the presented device comprises not-represented transport means, which are disposed alongside with respect to the direction of movement of the metal band. In order to allow for a transport, it is therefore intended for at least the lower process foil 11, but especially for both process foils 11, 21, that the foils be broader than the laminate to be manufactured, and thereby especially than the semi-manufactured product, which in this case is a metal band. The sections of the process foil extending laterally with respect to the metal band may therefore now be engaged to in line with the laminate, for example by means of engagement cheeks, from above and below, in order to obtain a movement directed from right to left in the drawing, without an engagement with the product to be manufactured itself being necessary. After a practically closed space is formed by means of the process foils, there do practically not arise any problems with laterally exiting resin. Since the lower process foil 11 protects the surface of the metal band 31 during the whole manufacturing procedure, pre-treated metal bands or other semi-manufactured products may be applied, for example coated, enamaling painted or otherwise treated ones, and also those having a sensitive surface. By means of the upper process foil, a high surface smoothness of the product may be assured, since for example an adhering with respect to the calender may completely be excluded.

Besides outstanding surface properties, the manufactured laminates are also distinguished by an extremely high bonding between synthetics and semi-manufactured product. Although the reasons for the increased bonding could not yet be completely examined, it is, to the one hand, assumed that these result from the continuous nature of the manufacturing procedure itself—especially depositions of dust as well as material alterations in the molding resin may easily be avoided during continuous procedures, in which context, to the other hand, also the elimination of air between the two process foils seems to have a substantial influence, since the synthetics material may practically be laminated directly to the semi-manufactured product, for example the metal band, while substantially excluding air. Basically, additional adherence imparting systems may improve the bonding between synthetics and semi-manufactured product though. The adherence imparting systems are each adapted to the applied semi-manufactured product and the applied synthetics. Due to the variety of possible adherence imparting systems, there shall be mentioned as examples only here: polyester systems, polyurethane systems, siloxane systems, silane systems, mercaptan systems and amine systems. These may be applied prior to depositing the resin to the semi-manufactured product, may be applied to the semi-manufactured product in a previous procedural step already, or may be added beforehand to the resin mixture.

In order to assure an even higher dustfreeness or also evacuation of air from the laminate to be manufactured, it is of course possible to provide respective evacuation means, which may for example serve to have the lower foil be two-dimensionally contacting the semi-manufactured product or metal band, or that respective exhausting air may be sucked off from the resin, namely before or after the calender.

In FIG. 3, a device is shown in schematic side view, which allows for the manufacturing of a synthetics/metal laminate in the table-based procedure. According to the shown embodiment, the device comprises a first material storage 310, which may dispense a process foil 311, in case this is used. Further, the shown device comprises a storage/dispensing facility 330 for providing a metal band 331, which, as is shown, is laid on the table 370 or the optionally intermediate process foil 310, respectively, prior to the subsequent operational steps. Thereby, the width of the table 370 is broader than that of the metal band 331. In the region, where the metal band 331 and the table surface 370 or the optional intermediate process foil 311, respectively, are brought together, an optional sealing facility is provided, as shown in FIG. 2. This adhers to the lateral edges of the metal band 331 at the table or the process foil, respectively, so that a fluid substance or a substance capable of flowing at the upper face of the metal band may neither reach the side faces nor the underlying face of the metal band. Further, a possible edge undulation of the metal band is thereby equalized or smoothened, respectively, so that the material yield of the finished laminate is increased, especially in the side areas.

The device shown in FIG. 3 further comprises a laminating facility 340, which is movable with respect to the table. On top of it, the hardenable synthetics 341, as well as optional reinforcement material 346 may be transported and dispensed. Moreover, auf the laminating facility, there may be a device allowing for the above mentioned sealing of the semi-manufactured product band with respect to the table. By moving, the laminating facility 340 and/or the table 370 with respect to each other, in one or several pass-throughs, respectively, the semi-manufactured product is sealed with respect to the table, the hardenable synthetics 341 is applied, as well as the optional reinforcement material 346 is introduced into the hardenable synthetics 341 from out of the model/reservoir 345. As the case may be, a further processing foil 321, being provided/stored in the storage 320, is laid-on after the deposition of the synthetics and the reinforcement material.

Therefore, this special embodiment also makes use of the advantages, which result from the sealing of the semi-manufactured product with respect to the underlying surface, as especially avoiding, that the un-hardened synthetics may enter below the lower side of the semi-manufactured product.

The described embodiments further comprise optional steps of after-treatment, especially the treatment of the synthetics side, for example by roughening or coronary treatment in preparation of a subsequent gluing. Further, a seaming may be effected, and the lateral region of the sealing may be removed.

Of course, various changes and modifications are possible for the device according to the invention, as well as the method according to the invention, without departing from the claimed scope. It is further claimed: the spreading of hardenable synthetics to the process foil or the table and the subsequent depositing of the semi-manufactured product band, which is sealed with respect to the upper process foil. Finally, it is essential, that the invention provides a method, wherein the semi-manufactured product band is sealed with respect to the surface laying behind it, whereby the manufacturing of laminates containing highly valuable semi-manufactured product with increased yield of material is allowed for in an effective and simple manner, the high-quality property being reflected, besides others, in the surface properties, and in fact as far as the semi-manufactured product is concerned, and as far as the synthetics is concerned, as well as in the deformability and durability of the end product. The hardening by supply of heat, which is presented as an example only, may be supplemented with or replaced by a hardening at ambient temperature and/or hardening by UV as well.

1. Method for manufacturing a laminate (100) comprising the steps:
providing at least one continuous process foil (11)
depositing a continuous, substantially non-polymeric semi-manufactured product band (31) to the process foil (11)
sealing the semi-manufactured product band (31) with respect to the process foils (11)
depositing a hardenable synthetics (41) to the semi-manufactured product band (31)
hardening the synthetics, while providing a bonding between the synthetics and the semi-manufactured product.

2. Method according to claim 1, further comprising the step of depositing a second continuous process foil (21) on the hardenable synthetics.

3. Method according to claim 1 or 2, further comprising the step of introducing reinforcement material into the hardenable synthetics.

4. Method according to one of the preceding claims, further comprising the step of calendering by means of a calender (50), especially preferably immediately prior to the hardening step.

5. Method according to one of the preceding claims, wherein the space between the process foils (11, 21) and/or one process foil (11, 21) and the semi-manufactured product band (31) is evacuated.

6. Method according to one of the preceding claims, characterized in that at least one process foil (11, 21) protrudes laterally beyond the semi-manufactured product band (31) in order to allow for an engagement by transport means.

7. Method according to one of claims 2 to 6, characterized in that the process foils (11, 21) laterally alongside/beside the semi-manufactured product band (31) may be engaged with one another, especially substantially in a sealing manner.

8. Method according to one of the preceding claims, characterized in that the semi-manufactured product band (31), is practically not permeable with respect to the hardenable synthetics.

9. Method according to one of the preceding claims, characterized in that the semi-manufactured product band (31) is a metal band, especially a coated metal band and/or a surface treated metal band.

10. Device for carrying out a method according to one of the preceding claims, comprising material storage(s) (10) for continuous dispensing of at least one process foil (11), a storage dispensing device (30) for continuous provision of a substantially non-polymeric semi-manufactured product band (31), a sealing device for sealing the semi-manufactured product with respect to the process foil, as well as a device (40) for storing and dispensing of hardenable synthetics (41) in a continuous manner.

11. Device according to claim 10, comprising a further material storage (20) for continuously dispensing at least one process foil (21).

12. Device according to claim 10 or 11, wherein the sealing device for sealing the semi-manufactured product with respect to one of the process foils comprises a gluing tape dispensing facility having optimal impact means.

13. Device according to claim 10, 11 or 12, comprising a synthetics distributing facility (44) and/or a synthetics impact facility (50), especially in form of a spreading knife (44) and/or a calender (50).

14. Device according to claim 10, 11, 12, or 13, further comprising a facility (45) for storing and continuously dispensing of reinforcement material (46).

15. Device according to one of the claims 10 to 14, further comprising a heating device (60), especially a continuously feedable heating and tempering table.

16. Device according to one of the claims 10 to 15, further comprising a forwarding means, which may be engaged with at least one of the process foils (11, 21) alongside/beside the semi-manufactured product band (31).

17. Device according to claim 16, wherein the forwarding means are designed in such a way that a sealing engagement between two process foils (11, 21) is enabled.

18. Method for manufacturing a laminate (300), comprising the steps:
providing a support surface (370) having predetermined dimensions
providing at least one optional first process foil (311)
depositing a substantially non-polymeric semi-manufactured product band (331) to the support surface or the optional process foil (311)
sealing the semi-manufactured product band (331) with respect to the support surface or the optional first process foil (311)
depositing a hardenable synthetics (341) to the semi-manufactured product band (331)
hardening the synthetics while depositing a bonding between the synthetics and the semi-manufactured product.

19. Method according to claim 18, further comprising the step of depositing a second process foil (321) to the hardenable synthetics.

20. Method according to claim 18 or 19, further comprising the step of introducing reinforcement material into the hardenable synthetics.

21. Method according to one of claims 18 to 20, wherein the space between the process foils (311, 321) and/or one process foil (311, 321) and the semi-manufactured product band (331) is evacuated.

22. Method according to one of claims 19 to 21, characterized in that the process foils (311, 321) may be engaged with each other laterally alongside/beside the semi-manufactured product band (331), especially in a substantially sealing manner.

23. Method according to one of claims 18 to 22, characterized in that the semi-manufactured product band (331) is practically impermeable with respect to the hardenable synthetics.

24. Method according to one of claims 18 to 23, wherein the semi-manufactured product band (331) is a metal band, especially a coated metal band and/or a surface treated metal band.

25. Method according to one of claims 18 to 24, further comprising the step of grinding the backside of the hardened synthetics.

26. Device for carrying-out a method according to one of the claims 18 to 25, comprising a support surface (370) having predetermined dimensions, an optional material storage (310) for dispensing at least one optional first process foil (311), a storage dispensing device (330) for providing a substantially non-polymeric semi-manufactured product band (331), a sealing device for sealing the semi-manufactured product with respect to the support surface or the optional process foil, as well as at least one laminating facility (340) ), which may be moved relative to the support surface (370), for storing and dispensing of hardenable synthetics (341.

27. Device according to claim 26, comprising a further material storage (320) for dispensing at least one process foil (321).

28. Device according to claim 26 or 27, wherein the sealing device, in order to seal the semi-manufactured product with respect to one of the process foils, comprises a gluing tape dispensing device having optimal/optional impact means.

29. Device according to one of claims 26 to 28, further comprising a laminating facility (345) for storing and dispensing reinforcement material (346).

30. Synthetics/metal laminate, which is manufactured according to one of claims 1 to 9 or 18 to 25 and/or by means of a device according to one of the claims 10 to 17 or 26 to 29, which especially does not show any deformation during ballistic impact with spheres having a diameter of 20 mm at a velocity of 20 m/s.
